(19) United States
(12) Patent Application Publication
(10) Pub. No.: US 2024/0230160 A9
(43) Pub. Date: Jul. 11, 2024

(54) HEATING CONTROL FOR PAINTING ASSEMBLY

(71) Applicant: Honda Motor Co., Ltd., Tokyo (JP)

(72) Inventor: ROBERT M UYEKI, Torrance, CA (US)

(21) Appl. No.: 17/972,423

(22) Filed: Oct. 24, 2022

(51) Int. Cl. F24H 15/148; F24H 1/00; G05D 23/19

(52) U.S. Cl. CPC F24H 15/148; F24H 1/0072; G05D 23/1904

(57) ABSTRACT

A controller for a painting assembly is provided. The controller includes at least one processor to set a threshold temperature to heat components of the painting assembly. The threshold temperature is set based on a carbon footprint in the painting assembly. The processor controls a first heater to generate the heat for a first duration for the components of the painting assembly. The first duration is determined based on the set threshold temperature. The processor compares a temperature of the components of the painting assembly with the set threshold temperature to determine a state of heat of the components of the painting assembly. The processor further controls a second heater to generate the heat for a second duration for the components of the painting assembly. The second duration is determined based on the comparison.

### BACKGROUND

Painting assembly typically includes painting ingredients (such as paints, emulsions, binders, etc.) that may be adhered on components (such as vehicle parts) in an assembly line. The painting ingredients are generally activated based on an application of heat (such as, via a natural gas heater) and the activated painting ingredients may be adhered on to the components in the assembly line. In certain cases, the application of heat (such as, via the natural gas heater) may contribute to release of carbon emissions (such as carbon dioxide or other greenhouse gases) in an environment, as a byproduct. Such carbon emissions may create pollution and impact the environment of the painting assembly. Therefore, there may be a need for a system that may control the carbon emission during the application of heat in the painting assembly.

Further limitations and disadvantages of conventional and traditional approaches will become apparent to one of skill in the art, through comparison of described systems with some aspects of the present disclosure, as set forth in the remainder of the present application and with reference to the drawings.

### SUMMARY

According to an embodiment of the disclosure, a controller for a painting assembly is provided. The controller may include at least one processor that may set a threshold temperature to heat components of the painting assembly. The threshold temperature may be set based on a carbon footprint in the painting assembly. The at least one processor may control a first heater to generate the heat for a first duration for the components of the painting assembly. The first duration may be determined based on the set threshold temperature. The at least one processor may compare a temperature of the components of the painting assembly with the set threshold temperature to determine a state of heat of the components of the painting assembly. The at least one processor may further control a second heater to generate the heat for a second duration for the components of the painting assembly. The second duration may be determined based on the comparison.

According to an embodiment of the disclosure, a painting assembly is provided. The painting assembly may include a first heater coupled to components of the painting assembly. The first heater may generate heat for a first duration to heat the components of the painting assembly. The first duration may be determined based on a threshold temperature that may be set to control a carbon footprint in the painting assembly. The painting assembly may further include a second heater coupled to the components of the painting assembly. The second heater may be configured to generate heat for a second duration to heat the components of the painting assembly. The second duration may be determined based on a comparison of a temperature of the components of the painting assembly with the threshold temperature. The temperature of the components may indicate a state of heat of the components of the painting assembly.

According to another embodiment of the disclosure, a method for heating control of a painting assembly is provided. The method may include setting a threshold temperature to heat components of a painting assembly. The threshold temperature may be set based on a carbon footprint in the painting assembly. The method may further include controlling a first heater to generate the heat for a first duration to heat the components of the painting assembly. The first duration may be determined based on the threshold temperature. The method may further include comparing a temperature of the components of the painting assembly with the set threshold temperature to determine a state of heat of the components of the painting assembly. The method may further include controlling a second heater to generate the heat for a second duration for the components of the painting assembly. The second duration may be determined based on the comparison.

### BRIEF DESCRIPTION OF THE DRAWINGS

FIG. 1 is a block diagram that illustrates an exemplary network environment to control the heat for components of a painting assembly by a controller, in accordance with an embodiment of the disclosure.

FIG. 2 is a block diagram that illustrates an exemplary controller of FIG. 1 to control the heat for components of the painting assembly, in accordance with an embodiment of the disclosure.

FIG. 3 depicts a first sequence diagram that illustrates exemplary operations to control the heat for components of the painting assembly by the controller of FIG. 1, in accordance with an embodiment of the disclosure.

FIG. 4 depicts a second sequence diagram that illustrates exemplary operations to control the heat for components of the painting assembly by the controller of FIG. 1, in accordance with an embodiment of the disclosure.

FIG. 5 depicts a chart that illustrates a first exemplary operation timeline of the controller of FIG. 1, to control the heat for components of the painting assembly, in accordance with an embodiment of the disclosure.

FIG. 6 depicts a chart that illustrates a second exemplary operation timeline of the controller of FIG. 1, to control the heat for components of the painting assembly, in accordance with an embodiment of the disclosure.

FIG. 7 depicts a chart that illustrates a third exemplary operation timeline of the controller of FIG. 1, to control the heat for components of the painting assembly, in accordance with an embodiment of the disclosure.

FIG. 8 is a flowchart that illustrates exemplary operations to control the heat for components of the painting assembly, in accordance with an embodiment of the disclosure.

The foregoing summary, as well as the following detailed description of the present disclosure, is better understood when read in conjunction with the appended drawings. For the purpose of illustrating the present disclosure, exemplary constructions of the preferred embodiment are shown in the drawings. However, the present disclosure is not limited to the specific methods and structures disclosed herein. The description of a method step or a structure referenced by a numeral in a drawing is applicable to the description of that method step or structure shown by that same numeral in any subsequent drawing herein.

### DETAILED DESCRIPTION

The following described implementations may be found in a disclosed controller for a heating control of a painting assembly. Exemplary aspects of the disclosure may provide a controller (such as an electronic control unit). The controller may set a threshold temperature to heat one or more components (such as vehicle parts) of the painting assembly. The threshold temperature may be set based on a carbon footprint in the painting assembly. In an example, the controller may optimally control a temperature for heating the components of the painting assembly, such that, an amount of carbon emission that may be formed during an application of heat on the components of the painting assembly may not exceed the threshold temperature.

The controller may control a first heater (such as a natural gas-based heater) to generate the heat for a first duration (such as, hours, or days) for the components of the painting assembly. In an example, the first duration may correspond to a first amount of time (for example, few hours) required to heat the components of the painting assembly to rapidly reach the threshold temperature. Such rapid heating of the components of the painting assembly may save time of an operator in an assembly line.

The controller may further control a second heater (such as a solar energy-based heater) to generate the heat for a second duration (such as, hours, or days) for the components of the painting assembly. In an example, the second duration may correspond to a second amount of time (for example, few hours, but more than the first amount of time) required to maintain the heat of the components of the painting assembly at the threshold temperature, based on a clean energy source (such as a solar power) associated with the second heater. Such clean energy-based heating of the components of the painting assembly may substantially reduce the carbon emissions during the heating of the components of the painting assembly.

The controller may further control switching between the first heater (i.e., a rapid heating) and the second heater (i.e., a clean-energy based heating) to generate the heat for the components of the painting assembly based on a user preference. For example, in case the user preference is to rapidly heat the components of the painting assembly, the controller may switch to the first heater. In another example, in case the user preference is to reduce carbon emissions, the controller may selectively switch between the first heater and the second heater, and thus, further reduce the carbon emissions during the heating of the components of the painting assembly.

Reference will now be made in detail to specific aspects or features, examples of which are illustrated in the accompanying drawings. Wherever possible, corresponding, or similar reference numbers will be used throughout the drawings to refer to the same or corresponding parts.

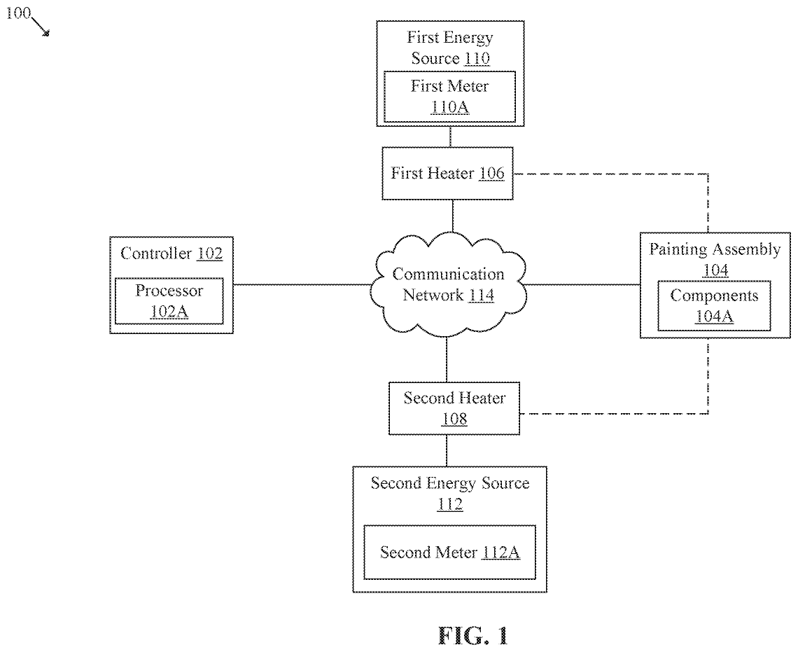

FIG. 1 is a block diagram that illustrates an exemplary network environment to control the heat for components of a painting assembly by a controller, in accordance with an embodiment of the disclosure. With reference to FIG. 1, there is shown a network environment 100 which may include a controller 102. The controller 102 may include a processor 102A, which may be communicatively coupled with at least one of: a painting assembly 104 and/or components 104A of the painting assembly 104, a first heater 106, and a second heater 108, via a communication network 114. The first heater 106 may be communicably coupled with a first energy source 110 and/or with a first meter 110A of the first energy source 110. The second heater 108 may be communicably coupled with a second energy source 112 and/or with a second meter 112A of the second energy source 112. In an embodiment, the first heater 106 and the second heater 108 may include the first meter 110A and the second meter 112A, respectively. In certain cases, modifications, additions, or omissions may be made to FIG. 1 without departing from the scope of the present disclosure. For example, the network environment 100 may include more or fewer elements, which may be communicably coupled with the controller 102, than those illustrated and described in the present disclosure.

The controller 102 may include suitable logic, circuitry, interfaces, and/or code that may be configured to store information associated with a threshold temperature that may be required to heat the components 104A of the painting assembly 104. In an embodiment, the controller 102 may controls at least one of: the first heater 106 or the second heater 108 to heat the components 104A of the painting assembly 104. Examples of the controller 102 may include, but not limited to, an electronic control unit (ECU), a control system, an embedded device, a smartphone, a human-machine interface (HMI), a computer workstation, a handheld computer, a cellular/mobile phone, a portable consumer electronic (CE) device, or a server such as, an event server, a database server, a file server, a web server, a media server, a content server, an application server, a mainframe server, and other computing devices, which may control other components of the painting assembly 104, based on control instructions from the processor 102A.

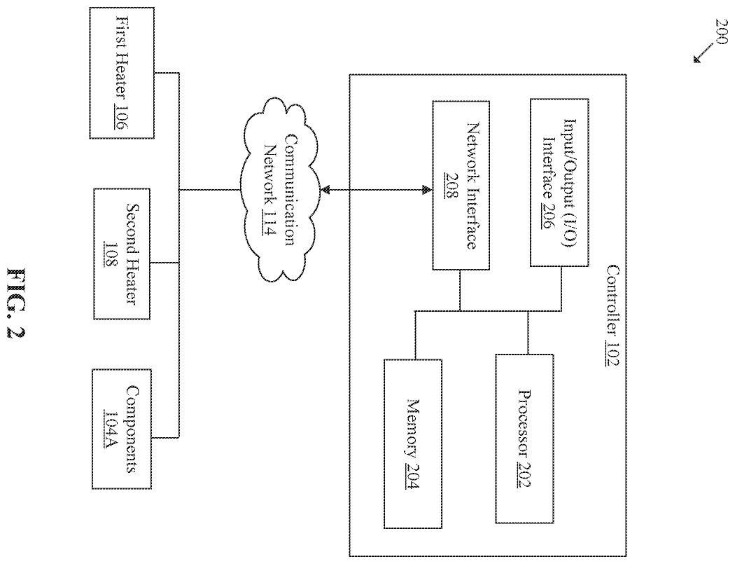

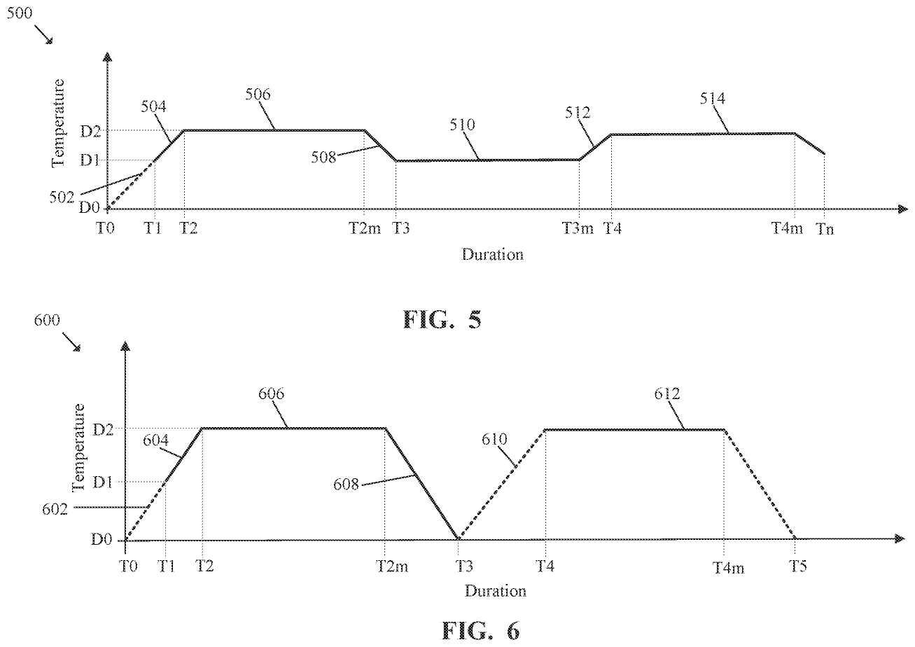

The processor 102A may include suitable logic, circuitry, and interfaces that may be configured to execute a set of instructions stored in a memory (as shown in FIG. 2) of the controller 102. The processor 102A may be configured to execute program instructions associated with different operations to be executed by the controller 102. For example, some of the operations may include setting of the threshold temperature to heat the components 104A of the painting assembly 104, control of the first heater 106 to generate the heat for a first duration (as shown in FIG. 5) for the components 104A of the painting assembly 104, comparison of a temperature of the components 104A of the painting assembly 104 with the set threshold temperature (to determine a state of heat of the components 104A of the painting assembly 104), and control of the second heater 108 to generate the heat for a second duration (as shown in FIG. 5), determined based on the comparison, for the components 104A of the painting assembly 104. The processor 102A may be implemented based on a number of processor technologies known in the art. Examples of the processor technologies may include, but are not limited to, a Central Processing Unit (CPU), X86-based processor, a Reduced Instruction Set Computing (RISC) processor, an Application-Specific Integrated Circuit (ASIC) processor, a Complex Instruction Set Computing (CISC) processor, a Graphical Processing Unit (GPU), and other processors, which may be configured to control the components 104A of the painting assembly 104.

The painting assembly 104 may be include a collection of painting ingredients (such as the components 104A), which may be configured to receive the heat from at least one of: the first heater 106 or the second heater 108, based on the control instructions from the processor 102A. In an example, the painting assembly 104 may be incorporated in an assembly line of a vehicle manufacturing plant to paint components (such as door panels, roof panels, etc.) of a vehicle. In another example, the painting assembly 104 may be incorporated in an assembly line of any plant (such as, consumer electronics manufacturing plant) other than the vehicle manufacturing plant, to paint components (such as mobile-phone panels, laptop panels, etc.) of a system in such assembly line.

The components 104A of the painting assembly 104 may include a paint (such as, paints, emulsions, binders, etc.). Each of the first heater 106 and/or the second heater 108 may be configured to control a temperature of the paint in the painting assembly 104. In another embodiment, the components 104A of the painting assembly 104 may include a painted component (such as, a painted car-door panel, a painted vehicle-roof panel, a painted laptop panel, etc.). Each of the first heater 106 and the second heater 108 may be configured to cure (such as, to perform heat treatment) the painted component in the painting assembly 104. For example, the components 104A of the painting assembly 104 may receive the heat from the first heater 106 or the second heater 108 to activate its painting ingredients (such as, paints, emulsions, binders, etc.). Based on the activation of the painting ingredients of the components 104A, the painting ingredients may be adhered on to the components 104A in the assembly line.

The first heater 106 may be coupled to components 104A of the painting assembly 104. In an embodiment, the painting assembly 104 may include the first heater 106 which may be coupled to components 104A of the painting assembly 104. In an embodiment, the first heater 106 may be configured to generate the heat for a first duration (such as, hours, or days) for the components 104A of the painting assembly 104. In an example, the first duration may correspond to a first amount of time (for example, 3 hours) required to heat the components 104A of the painting assembly 104 to rapidly reach the threshold temperature. In certain cases, there may be a requirement to speed-up a painting process in the painting assembly 104 to optimize production time. In such cases, the rapid heating of the components 104A of the painting assembly 104 may facilitate a quick adhering of the painting ingredients on to the components 104A and may save a substantial amount time for an operator in the assembly line. In an embodiment, the first heater 106 may be a renewable-energy source based heater. For example, the first heater 106 may include, but are not limited to, the natural gas-based heater, a coal-based heater, an oil-based heater, or a fossil fuel-based heater, which may receive the heat from the first energy source 110 and transfer such heat to the components 104A of the painting assembly 104.

The first energy source 110 may be a renewable-energy source (such as a natural gas-based energy source). The first energy source 110 may be communicably coupled with the first heater 106 to generate the heat for the first duration (such as, hours, or days) for the components 104A of the painting assembly 104. The first heater 106 may be controlled based on the first energy source 110. In an embodiment, an amount of energy consumed by the first heater 106 may be measured via the first meter 110A of the first energy source 110 and displayed as energy readings in the first meter 110A. The energy readings from the first meter 110A may correspond to a carbon footprint (such as, carbon emissions) in the painting assembly 104. In an example, the carbon footprint may relate to information associated with an amount of carbon spent based on a usage of the first heater 106. Examples of the first energy source 110 may include, but are not limited to, a natural gas-based energy source, a coal-based energy source, an oil-based energy source, or a fossil fuel-based energy source.

The second heater 108 may be coupled to the components 104A of the painting assembly 104. In an embodiment, the painting assembly 104 may include the second heater 108 which may be coupled to components 104A of the painting assembly 104. In an embodiment, the second heater 108 may be configured to generate the heat for a second duration (such as, hours, or days) for the components 104A of the painting assembly 104. In an example, the second duration may correspond to a second amount of time (for example, 9 hours) required to heat the components 104A of the painting assembly 104 to maintain the threshold temperature with a substantially minimal carbon emissions compared to a carbon emission of the first heater 106. In an embodiment, the second duration may be determined based on a comparison of a temperature of the components 104A of the painting assembly 104 with the threshold temperature. The temperature of the components 104A may indicate a state of heat (such as, a heat-state, or a non-heat-state) of the components 104A of the painting assembly 104.

In certain cases, there may be a requirement to limit carbon emissions in the painting assembly 104, to reduce a pollution in an environment of the painting assembly 104. In such cases, the clean-energy-based heating of the components 104A of the painting assembly 104 may substantially control the carbon emissions from the painting assembly 104.

In an embodiment, the carbon footprint (i.e., the carbon emissions) in the painting assembly 104 may be offset based on a cyclic usage (as shown in FIG. 5) of the second heater 108, such that, the cyclic usage may correspond to a repeated schedule (as shown in FIG. 5) of heating the components 104A of the painting assembly 104, via the second heater 108. In an embodiment, the second heater 108 may be a clean-energy source based heater. Examples of the second heater 108 may include, but are not limited to, a solar energy-based heater, a wind energy-based heater, a geothermal energy-based heater, or a hydro-power based-heater, which may receive the heat from the second energy source 112 and transfer such heat to the components 104A of the painting assembly 104.

The second energy source 112 may be a clean-energy source (such as a solar energy source). The second energy source 112 may be communicably coupled with the second heater 108 to generate the heat for the second duration (such as, hours, or days) for the components 104A of the painting assembly 104. In an embodiment, the seconds heater 108 may be controlled based on the second energy source 112. In an example, the first energy source 110 may be different form the second energy source 112. In an alternate example, the first energy source 110 may also be selected from the clean-energy source, (such as, a wind-energy source) based on the user preference on the control of carbon emissions. Examples of the second energy source 112 may include, but are not limited to, the solar energy source, the wind energy source, a geothermal energy source, or a hydro-power energy source.

In an embodiment, the second energy source 112 may be communicably coupled to the second meter 112A, such that, an amount of energy consumed by the second heater 108 may be measured via the second meter 112A. The measured readings may be displayed as energy readings in the second meter 112A. The energy readings from the second meter 112A may correspond to carbon credits for the painting assembly 104. In an example, the carbon credits may relate to information associated with an amount of carbon saved based on a usage of the second heater 108. In another example, the carbon credits may relate to information associated with an amount of carbon credits earned based on the clean-energy-based heating of the components 104A of the painting assembly 104.

The communication network 114 may include a communication medium through which the controller 102, the first heater 106, the second heater 108, and the painting assembly 104 may communicate with each other. In an embodiment, various devices in the network environment 100 (such as components of the first heater 106, the second heater 108, and the painting assembly 104) may be configured to connect to the communication network 114 in accordance with various wired and wireless communication protocols. Examples of such wired and wireless communication protocols may include, but are not limited to, at least one of a Transmission Control Protocol and Internet Protocol (TCP/IP), User Datagram Protocol (UDP), Hypertext Transfer Protocol (HTTP), File Transfer Protocol (FTP), Zig Bee, EDGE, IEEE 802.11, light fidelity (Li-Fi), 802.16, IEEE 802.11s, IEEE 802.11g, multi-hop communication, wireless access point (AP), device to device communication, cellular communication protocols, and Bluetooth (BT) communication protocols. The communication network 114 may be one of: a wired connection or a wireless connection. Examples of the communication network 114 may include, but are not limited to, the Internet, a cloud network, a Wireless Fidelity (Wi-Fi) network, a Personal Area Network (PAN), a Local Area Network (LAN), or a Metropolitan Area Network (MAN).

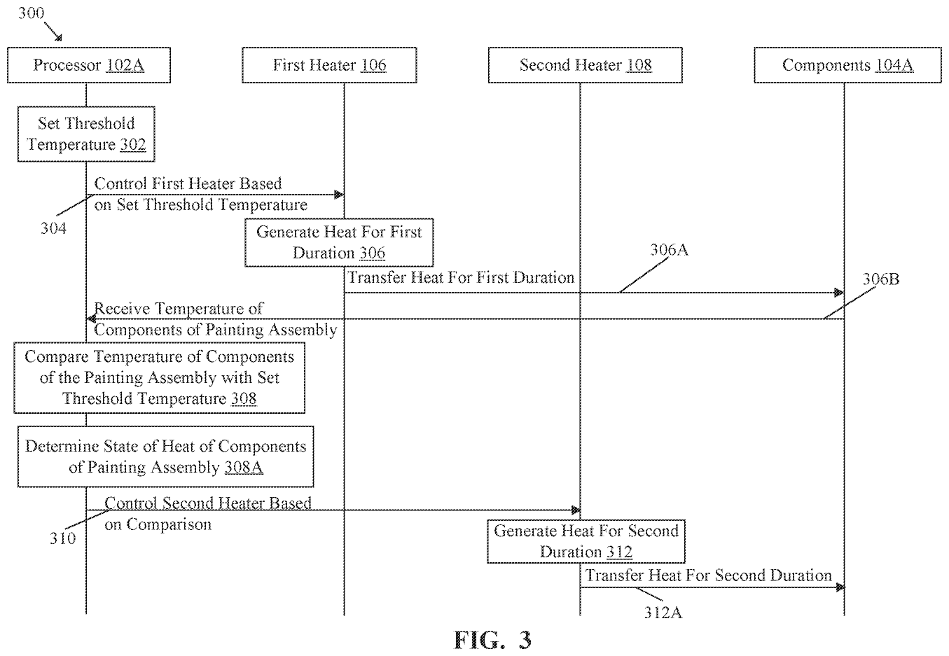

In operation, the controller 102 may set the threshold temperature to heat the components 104A of the painting assembly 104. In an embodiment, the threshold temperature may be set based on a carbon footprint in the painting assembly 104. The controller 102 may control the first heater 106 to generate the heat for the first duration (as shown in FIG. 5) for the components 104A of the painting assembly 104. In an embodiment, the first duration may be determined based on the set threshold temperature. The control of the first heater 106 to generate the heat for the components 104A is further described, for example, at 304 and 306 in FIG. 3. The controller 102 may further compare a temperature of the components 104A of the painting assembly 104 with the set threshold temperature to determine a state of heat of the components 104A of the painting assembly 104 as described, for example, at 308 and 308A in FIG. 3. The controller 102 may be further control the second heater 108 to generate the heat for the second duration (as shown in FIG. 5), determined based on the comparison, for the components 104A of the painting assembly 104. The control of the second heater 108 to generate the heat for the components 104A is further described, for example, at 310 and 312 in FIG. 3.

The controller 102 may further control switching between the first heater 106 (i.e., a rapid heating) and the second heater 108 (i.e., a clean-energy based heating) to generate the heat for the components 104A of the painting assembly 104 based on the user preference on the control of carbon emissions. For example, in case the user preference is to rapidly heat the components 104A of the painting assembly 104, the controller 102 may switch to the first heater 106. In another example, in case the user preference is to reduce and limit carbon emissions, the controller 102 may selectively switch from the first heater 106 to the second heater 108, to further reduce the carbon emissions during the heating of the components 104A of the painting assembly 104. In other words, the user preference may be based on the carbon footprint in the painting assembly 104. In an embodiment, the controller 102 may control each of the first heater 106 and the second heater 108 to concurrently heat the components 104A of the painting assembly 104 to reach the threshold temperature. In an example, the controller 102 simultaneously controls the first heater 106 and the second heater 108 to speed-up the painting process in the painting assembly 104. In another example, the controller 102 controls the first heater 106 and the second heater 108 sequentially to optimally control carbon emissions in the painting assembly 104. Details of the controller 102 is further described, for example, in FIG. 2.

FIG. 2 is a block diagram that illustrates an exemplary controller of FIG. 1 to control the heat for components of the painting assembly, in accordance with an embodiment of the disclosure. FIG. 2 is explained in conjunction with elements from FIG. 1. With reference to FIG. 2, there is shown a block diagram 200 of the controller 102. The controller 102 may include a processor 202, a memory 204, a I/O device 206, and a network interface 208. The processor 202 may be coupled to the memory 204, the I/O device 206, and the network interface 208, through wired or wireless connections of a communication network 114.

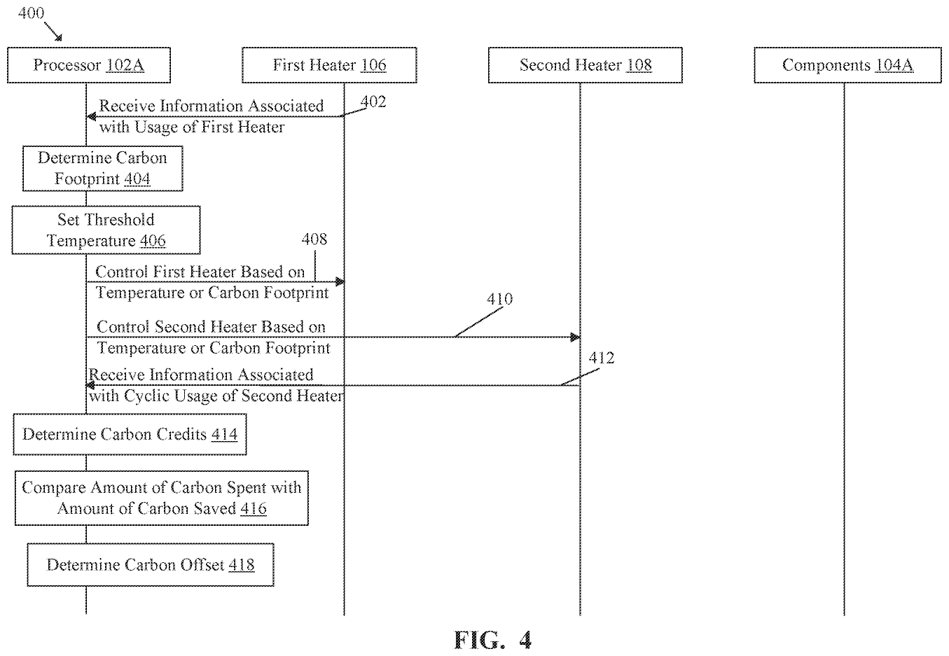

The processor 202 may include suitable logic, circuitry, and/or interfaces that may be configured to execute program instructions associated with different operations to be executed by the controller 102. For example, some of the operations may include, but are not limited to, setting of the threshold temperature to heat the components 104A of the painting assembly 104, control of the first heater 106 to generate the heat for a first duration (as shown in FIG. 5) for the components 104A of the painting assembly 104, comparison of a temperature of the components 104A of the painting assembly 104 with the set threshold temperature to determine a state of heat of the components 104A of the painting assembly 104, control of the second heater 108 to generate the heat for a second duration (as shown in FIG. 5), determined based on the comparison, for the components 104A of the painting assembly 104. The execution of operations is further explained, for example, in FIGS. 3-4. However, the functions of the processor 202 may be same as the functions of the processor 102A described, for example, in FIG. 1. Therefore, further description of the processor 202 is omitted from the disclosure for the sake of brevity.

The memory 204 may include suitable logic, circuitry, interfaces, and/or code that may be configured to store the set of instructions executable by the processor 202 and/or the processor 102A. The memory 204 may be configured to store information associated with the threshold temperature to heat the components 104A of the painting assembly 104, information associated with the carbon footprint in the painting assembly 104, information associated with the first duration for the first heater 106, information associated with the second duration for the second heater 108, information associated with a third duration for the second heater 108, information associated with a fourth duration for the first heater 106, and information associated with carbon credits of the painting assembly 104. Examples of implementation of the memory 204 may include, but are not limited to, Random Access Memory (RAM), Read Only Memory (ROM), Hard Disk Drive (HDD), a Solid-State Drive (SSD), a CPU cache, and/or a Secure Digital (SD) card.

The I/O device 206 may include suitable logic, circuitry, interfaces, and/or code that may be configured to receive user inputs and generate outputs in response to the received user inputs. The I/O device 206 may receive information associated with the threshold temperature, information associated with a temperature of the first heater 106, or information associated with a temperature of the second heater 108 as a user-input. For example, the controller 102 may receive the user-input from an operator of the assembly line to control at least one of: the first heater 106 or the second heater 108, based on the user inputs or preferences. The I/O device 206 may include various input and output devices, may be configured to communicate with the processor 202. Examples of the I/O device 206 may include, but are not limited to, a touch screen, a keyboard, a mouse, a joystick, a microphone, a display device, a speaker, and/or an image sensor.

The network interface 208 may include suitable logic, circuitry, and interfaces that may be configured to facilitate communication between the processor 202, the first heater 106, the second heater 108, and the components 104A of the painting assembly 104, via the communication network 114. The network interface 208 may be implemented by use of various known technologies to support wired or wireless communication of the controller 102 with the communication network 114. The network interface 208 may include, but is not limited to, an antenna, a radio frequency (RF) transceiver, one or more amplifiers, a tuner, one or more oscillators, a digital signal processor, a coder-decoder (CODEC) chipset, a subscriber identity module (SIM) card, or a local buffer circuitry. The network interface 208 may be configured to communicate via wireless communication with networks, such as the Internet, an Intranet, or a wireless network, such as a cellular telephone network, a wireless local area network (LAN), and a metropolitan area network (MAN). The wireless communication may be configured to use one or more of a plurality of communication standards, protocols and technologies, such as Global System for Mobile Communications (GSM), Enhanced Data GSM Environment (EDGE), wideband code division multiple access (W-CDMA), Long Term Evolution (LTE), code division multiple access (CDMA), time division multiple access (TDMA), Bluetooth, Wireless Fidelity (Wi-Fi) (such as IEEE 802.11a, IEEE 802.11b, IEEE 802.11g or IEEE 802.11n), voice over Internet Protocol (VoIP), light fidelity (Li-Fi), Worldwide Interoperability for Microwave Access (Wi-MAX), a protocol for email, instant messaging, and a Short Message Service (SMS).

Although in FIG. 2, it is shown that the controller 102 includes the processor 202, the memory 204, the I/O device 206, and the network interface 208; the disclosure may not be limiting and the controller 102 may include more or less components to perform the same or other functions of the controller 102. Details of the other functions and the components have been omitted from the disclosure for the sake of brevity. The functions or operations executed by the controller 102, as described in FIG. 1, may be performed by the processor 202 and/or the processor 102A. Operations executed by the controller 102 are further described, for example, in the FIGS. 3-4.

FIG. 3 depicts a first sequence diagram that illustrates exemplary operations to control the heat for components of the painting assembly by the controller of FIG. 1, in accordance with an embodiment of the disclosure. FIG. 3 is explained in conjunction with elements from FIG. 1 and FIG. 2. With reference to FIG. 3, there is shown a first sequence diagram 300 of exemplary operations handled by the controller 102 or the processor 102A or the processor 202 to control the heat for components 104A of the painting assembly 104. In FIG. 3, the controller 102 or the processor 102A or the processor 202 performs the exemplary operations from 302 to 312A, which relates to control of the heat for components 104A of the painting assembly 104.

At 302, the threshold temperature may be set. In an embodiment, the processor 102A may set the threshold temperature to heat the components 104A of the painting assembly 104. In an example, the threshold temperature may be a minimum temperature that may be required for the painting ingredients (such as the paint, the emulsion, the binder, etc.) of the components (such as the painted car-door panel) of the painting assembly 104. In another example, the threshold temperature may be set above 55 degrees Fahrenheit for adhering the painting ingredients on to the components 104A of the painting assembly 104. In yet another example, the threshold temperature may be set in a range between 55 degrees Fahrenheit to 85 degrees Fahrenheit for adhering the painting ingredients on to the components 104A of the painting assembly 104. In yet another example, the threshold temperature may also be set to cure or to perform a heat treatment on the painted components of the painting assembly 104. In another embodiment, the threshold temperature may be set based on the carbon footprint in the painting assembly 104. Details of the carbon footprint is further described, for example, in FIG. 4. In an embodiment, the processor 102A may receive user inputs from an operator of the painting assembly 104 and set the threshold temperature based on the received user inputs.

At 304, the first heater 106 may be controlled based on the threshold temperature. In an embodiment, the processor 102A may control the first heater 106 based on the set threshold temperature. In an example, in case the set threshold temperature is set between 55 degrees Fahrenheit and 85 degrees Fahrenheit, such as 70 degrees Fahrenheit, the processor 102A may control the first heater 106 to reach to a part (such as between 55 degrees 65 degrees) of the threshold temperature. In another example, in case the set threshold temperature is set between 55 degrees Fahrenheit and 85 degrees Fahrenheit, such as 70 degrees Fahrenheit, the processor 102A may control the first heater 106 to directly reach the threshold temperature (such as 70 degrees Fahrenheit). In an embodiment, the processor 102A may send one or more instructions (i.e., including information about the set threshold temperature) to the first heater 106 and further the first heater 106 may control internal heating (or heating of the painting ingredients or of the components 104A) based on the received instructions.

At 306, the first heater 106 may generate the heat for the first duration. In an embodiment, the processor 102A may control the first heater 106 to generate the heat for the first duration. In an embodiment, the first duration may correspond to the first amount of time (such as, minutes, hours, or even days) that may be required to heat the components 104A (or heat the painting ingredients) of the painting assembly 104 to reach the threshold temperature. In an example, the first duration may be 3 hours, which may start at 4 AM and end at 7 AM on a working day of the assembly line. In another example, the first duration may be a minimum of 3 hours, which may start at 4 AM and may end based on the user preference on a working day of the assembly line.

At 306A, the generated heat from the first heater 106 may be transferred to the components 104A of the painting assembly 104. In an embodiment, the heat from the first heater 106 may be transferred to the components 104A of the painting assembly 104, via at least one process of: conduction (for example, a heat transfer through a solid material such as a metal), convection (for example, a heat transfer through a fluid material such as liquid), or a radiation (for example, a heat transfer through an electromagnetic wave such as without any particle). The components 104A of the painting assembly 104 may be configured to receive the transferred heat from the first heater 106 to activate and adhere the painting ingredients (such as the paint, emulsions, binders, etc.) on to the components 104A of the painting assembly 104.

At 306B, a temperature of the components 104A of the painting assembly 104 may be received. In an embodiment, the processor 102A may receive the temperature of the components 104A, via the communication network 114. For example, there may be a temperature sensor (not shown) communicably coupled with the components 104A of the painting assembly 104 to detect a change in temperature of the components 104A of the painting assembly 104. Based on the detection, the temperature sensor may transmit the detected temperature of the components 104A to the processor 102A, via the communication network 114.

At 308, the temperature of the components 104A of the painting assembly 104 may be compared with the set threshold temperature. In an embodiment, the processor 102A may compare the received information about the temperature of the components 104A of the painting assembly 104 with the set threshold temperature. In other words, the processor 102A may compare the detected temperature from the temperature sensor (associated with the components 104A) with the preset threshold temperature. In an embodiment, the processor 102A may receive a plurality of temperature signals detected from multiple components of the painting assembly 104. In such cases, the processor 102A may compare the detected temperature for each component of the multiple components of the painting assembly 104 with the preset threshold temperature.

At 308A, a state of heat of the components 104A of the painting assembly 104 may be determined. In an embodiment, based on the comparison (performed at 308), the processor 102A may determine the state of heat (such as, a current temperature) of the components 104A of the painting assembly 104. For example, based on the detected temperature of the components 104A, the processor 102A may label the state of heat as one of: “low temperature”, “optimal temperature”, or “high temperature”. The “low temperature” label may indicate that the components 104A are at a temperature less than the threshold temperature and may require additional heating. The “high temperature” label may indicate that the components 104A are at a temperature more than the threshold temperature. The “optimal temperature” label may indicate that the components 104A are having a temperate that is substantially same as the set threshold temperature.

At 310, the second heater 108 may be controlled based on the comparison and the state of heat of the components 104A. In an embodiment, the processor 102A may control the second heater 108 based on the comparison. For example, in case the temperature of the components 104A is low, the processor 102A may control the second heater 108 to increase the temperature of the components 104A of the painting assembly 104 until the components 104A are re-labelled with the “optimal temperature” (i.e., until the detected temperature of the components 104A falls within the range between 55 degrees Fahrenheit and 85 degrees Fahrenheit as the set threshold temperature). In another example, in case the detected temperature of the components 104A is high, the processor 102A may control a cooling implement (not shown), coupled with the second heater 108, to reduce the temperature of the components 104A until the components 104A are labelled with the “optimal temperature” (i.e., until the detected temperature of the components 104A falls within the range between 55 degrees Fahrenheit and 85 degrees Fahrenheit as the set threshold temperature). In yet another example, in case the detected temperature is optimal, the painting process may be performed and the processor 102A may not activate the second heater 108 until the components 104A are labelled with the “low temperature” (i.e., until the detected temperature of the components 104A falls below 55 degrees Fahrenheit).

At 312, the second heater 108 may generate the heat for the second duration. In an embodiment, the processor 102A may control the second heater 108 to generate the heat for the second duration. In an embodiment, the second duration may correspond to the second amount of time (such as, minutes, hours, or even days) that may be required to maintain the heat of the components 104A of the painting assembly 104 at the threshold temperature. In an example, the second duration may be 9 hours, which may start at 7 AM and end at 4 PM on a working day of the assembly line. In another example, the first duration may be a minimum of 9 hours, which may start at 7 AM and may end based on the user preference on a working day of the assembly line. In an embodiment, the processor 102A may control the second heater 108 fora longer duration (i.e., second duration) to maintain the heat of the components 104A, than the first duration (i.e., for which the first heater 106 is controlled to heat the components 104A to reach the set threshold temperature).

At 312A, the generated heat from the second heater 108 may be transferred to the components 104A of the painting assembly 104. In an embodiment, the heat from the second heater 108 may be transferred to the components 104A of the painting assembly 104, via at least one process of: conduction (for example, a heat transfer through a solid material such as a metal), convection (for example, a heat transfer through a fluid material such as liquid), or a radiation (for example, a heat transfer through an electromagnetic wave such as without any particle). The components 104A of the painting assembly 104 may be configured to receive the transferred heat from the second heater 108 to activate and adhere the painting ingredients (such as the paint, emulsions, binders, etc.) on to the components 104A of the painting assembly 104.

The first sequence diagram shown in FIG. 3 is illustrated as discrete operations, such as from 302 to 312A, which relates to control of the heat for components 104A of the painting assembly 104. However, in certain embodiments, such discrete operations may be further divided into additional operations, combined into fewer operations, or eliminated, depending on the particular implementation without detracting from the essence of the disclosed embodiments.

FIG. 4 depicts a second sequence diagram that illustrates exemplary operations to control the heat for components of the painting assembly by the controller of FIG. 1, in accordance with an embodiment of the disclosure. FIG. 4 is explained in conjunction with elements from FIGS. 1, 2 and 3. With reference to FIG. 4, there is shown a second sequence diagram 400 of exemplary operations handled by the controller 102 or the processor 102A or the processor 202 to control the heat for components 104A of the painting assembly 104. In FIG. 4, the controller 102 or the processor 102A or the processor 202 performs the exemplary operations from 402 to 418, which relates to control of the heat for components 104A of the painting assembly 104.

At 402, information associated with a usage of the first heater may be received. In an embodiment, the processor 102A may receive the information associated with the usage of the first heater 106, via the communication network 114. For example, the information may relate to one of: an amount of heat transferred to the components 104A of the painting assembly 104 from the first heater 106, a time period of application of heat from the first heater 106 to the components 104A of the painting assembly 104, or a type (for example, a continuous heat supply, or an intermittent/pulsed heat supply) of heat applied, from the first heater 106, to the components 104A of the painting assembly 104.

At 404, the carbon footprint may be determined. In an embodiment, the processor 102A may determine the carbon footprint of the painting assembly 104. In an example, the carbon footprint may relate to information associated with an amount of carbon spent based on the usage of the first heater 106 in the painting assembly 104. In an alternate example, the carbon footprint may relate to information associated with an amount of carbon spent based on a usage of the second heater 108 in the painting assembly 104. In yet another example, the carbon footprint may relate to information associated with an amount of carbon spent based on a usage of the first heater 106 and the second heater 108 in the painting assembly 104.

At 406, the threshold temperature may be set. In an embodiment, the processor 102A may set the threshold temperature based on the carbon footprint measured in the painting assembly 104. In an example, in case of increased carbon footprint, the processor 102A may set a minimal threshold temperature for the first heater 106 and/or the second heater 108. In another example, in case of minimal carbon footprint, the processor 102A may set a maximum threshold temperature for the first heater 106 and/or the second heater 108. Therefore, it may be observed that the threshold temperature for the painting assembly 104 is inversely proportional to an amount of carbon footprint in the painting assembly 104.

At 408, the first heater 106 may be controlled based on the set threshold temperature or the determined carbon footprint. In an embodiment, the processor 102A may control the first heater 106 based on the threshold temperature or the determined carbon footprint. In an example, in case of the increased carbon footprint, the processor 102A may limit the usage of the first heater 106. In another example, in case of the minimal carbon footprint, the processor 102A may increase the usage of the first heater 106. Therefore, it may be observed that the usage of the first heater 106 is inversely proportional to the amount of carbon footprint in the painting assembly 104. The description of the control of the first heater 106 based on the set threshold temperature is also described at 304 in FIG. 3.

At 410, the second heater 108 may be controlled based on the threshold temperature or the determined carbon footprint. In an embodiment, the processor 102A may control the second heater 108 based on the set threshold temperature or the determined carbon footprint. In an example, in case of the increased set threshold temperature (for example, based on increased carbon footprint), the processor 102A may increase the usage of the second heater 108. Because, in such cases, it may be necessary to limit the carbon footprint rather than speeding up the painting process by switching to the first heater 106. In another example, in case of the minimal set threshold temperature (for example, based on minimal carbon footprint), the processor 102A may limit the usage of the second heater 108. Because, in such cases, as there is only minimal carbon footprint, it may be preferred to switch to the first heater 106 and speed up the painting process and save time for the operator. Therefore, it may be observed that the usage of the second heater 108 is directly proportional to the amount of carbon footprint in the painting assembly 104.

At 412, information associated with a cyclic usage of the second heater 108 may be received. In an embodiment, the processor 102A may receive the information associated with the cyclic usage of the second heater 108. For example, the cyclic usage of the second heater 108 may correspond to a repeated schedule of heating the components 104A of the painting assembly 104, via the second heater 108. Details of the cyclic usage is further described, for example, in FIGS. 5-7.

At 414, carbon credits may be determined. In an embodiment, the processor 102A may determine the carbon credits based on the cyclic usage of the second heater 108. For example, the cyclic usage of the second heater 108 may provide carbon credits. The carbon credits may relate to information associated with the amount of carbon saved based on the usage of the second heater 108. The carbon credits are typically issued from a carbon regulatory authority (not shown) for the clean-energy usage, via the second heater 108. The processor 102A may receive the carbon credits from the carbon regulatory authority in a form of a tradable certificate. Such collection of the carbon credits in the tradable certificate may provide a legal permit to an authority (or to an owner) associated with the controller 102 (including the processor 102A) to utilize the first heater 106 and speed up the painting process. For example, based on user preference or inputs, the processor 102A may transmit a part of the collected carbon credits to the carbon regulatory authority and receive authorization to use the first heater 106 for a certain period of time. The certain period may be determined based on the transmitted part of the collected carbon credits and the corresponding carbon emissions from the first heater 106. The processor 102A may further utilize the first heater 106 for the certain period of time to speed up the painting process.

At 416, an amount of carbon spent may be compared with an amount of carbon saved. In an embodiment, the processor 102A may compare the amount of carbon spent with the amount of carbon saved. For example, the processor 102A may compare the amount of carbon spent based on the usage of the first heater 106, with the amount of carbon saved based on the usage of the second heater 108. The comparison may provide an effective amount of carbon saved, which may be determined based on a difference between the amount of carbon saved via the second heater 108 and the amount of carbon spent via the first heater 106. Such effective amount of carbon saved may indicate a reduction in carbon emissions in the painting assembly 104 based on the control of the processor 102A on the second heater 108.

At 418, a carbon offset may be determined. In an embodiment, the processor 102A may determine the carbon offset. Based on the comparison between the amount of carbon spent (based on the usage of the first heater 106), with the amount of carbon saved (based on the usage of the second heater 108), the processor 102A may determine the carbon offset of the carbon footprint. The carbon offset may indicate the effective amount of carbon saved, which may be determined based on the difference between the amount of carbon saved via the second heater 108 and the amount of carbon spent via the first heater 106. In an embodiment, based on the determined carbon offset, the processor 102A may transmit a part of the collected carbon credits to the carbon regulatory authority to nullify the carbon emissions that may be generated based on the usage of the first heater 106.

The second sequence diagram shown in FIG. 4 is illustrated as discrete operations, such as from 402 to 418, which relates to control of the heat for components 104A of the painting assembly 104. However, in certain embodiments, such discrete operations may be further divided into additional operations, combined into fewer operations, or eliminated, depending on the particular implementation without detracting from the essence of the disclosed embodiments.

FIG. 5 depicts a chart that illustrates a first exemplary operation timeline of the controller 102 of FIG. 1, to control the heat for components of the painting assembly, in accordance with an embodiment of the disclosure. FIG. 5 is explained in conjunction with elements from FIGS. 1, 2, 3, and 4. With reference to FIG. 5, there is shown a chart 500 indicating a first exemplary operation timeline of the controller 102 which depicts different phases of operation of the painting assembly 104. The different phases may include, but not limited to, an initial heating phase 502, a supplementary heating phase 504, a maintenance phase 506, a supplementary control phase 508, an idling phase 510, a re-heating phase 512, and a cyclic phase 514.

In the initial heating phase 502, the first heater 106 may be controlled to generate the heat for the components 104A of the painting assembly 104. In an embodiment, the processor 102A may control the first heater 106 to generate the heat for the components 104A of the painting assembly 104. The initial heating phase 502 may start at an initial time “T0” and proceed till a first time instance“T1”. In some cases, the first duration (“T0” to “T1”) may be determined based on a start of operations of the painting assembly 104. For example, the first duration (“T0” to “T1”) may be the first amount of time (for example, 3 hours) required to heat the components 104A of the painting assembly 104 to reach a part (such as a pre-heating temperature “D1”) of a threshold temperature “D2”, from an initial temperature “DO”. In another example, the pre-heating temperature “D1” (such as a first temperature) is less than the threshold temperature “D2”. In some cases, the pre-heating temperature “D1” (such as the first temperature) may be determined based on the carbon footprint in the painting assembly 104. In the initial heating phase 502, the first heater 106 may utilize the natural-gas-based energy source to quickly heat the components 104A of the painting assembly 104 from the initial temperature “D0” to the pre-heating temperature “D1”.

In the supplementary heating phase 504, the second heater 108 may be controlled to generate the heat for the components 104A of the painting assembly 104. In an embodiment, the processor 102A may control the second heater 108 to generate the heat for the components 104A of the painting assembly 104. The supplementary heating phase 504 may start from the first time instance “T1” and proceed till a second time instance “T2”. In some cases, the second duration (“T1” to “T2”) may be determined based on the working of operations of the painting assembly 104. For example, the second duration (“T1” to “T2”) may be a first preliminary amount of time (for example, 2-3 hours) required to heat the components 104A of the painting assembly 104 to reach the threshold temperature “D2” from the pre-heating temperature “D1” (i.e. the first temperature). In the supplementary heating phase 504, the second heater 108 may utilize the clean-energy-based source (such as the solar energy source) to heat the components 104A of the painting assembly 104 from the pre-heating temperature “D1” to the threshold temperature “D2”, with minimal carbon emissions.

In the maintenance phase 506, the second heater 108 may be controlled to maintain the heat for the components 104A of the painting assembly 104. In an embodiment, the processor 102A may control the second heater 108 to maintain the heat for the components 104A of the painting assembly 104. The maintenance phase 506 may start from the second time instance “T2” and proceed till a maintenance time instance “T2m”. In an example, a duration of a maintenance period (“T2” to “T2m”) may be the second amount of time (for example, 9 hours) required to maintain the heat of the components 104A of the painting assembly 104 at the threshold temperature “D2”. In another embodiment, a combination of the second duration (“T1” to “T2”) and the duration of the maintenance period (“T2” to “T2m”), may correspond to the second amount of time that may be required to reach the threshold temperature from the pre-heating temperature “D1” (i.e., the first temperature) and maintain the heat of the components 104A of the painting assembly 104 at the threshold temperature “T2”. In the maintenance phase 506, the second heater 108 may utilize the clean-energy-based source (such as the solar energy source) to maintain the heat of the components 104A of the painting assembly 104 at the threshold temperature “D2”, with minimal carbon emissions.

In the supplementary control phase 508, the second heater 108 may be controlled to reduce the heat for the components 104A of the painting assembly 104. In an embodiment, the processor 102A may control the second heater 108 to reduce the heat for the components 104A of the painting assembly 104. The supplementary control phase 508 may start from the maintenance time instance “T2m” and proceed till a third time instance “T3”. In an embodiment, the processor 102A may control the second heater 108 to reduce the heat for a third duration (“T2m” to “T3”) for the components 104A of the painting assembly 104. In some cases, the third duration (“T2m” to “T3”) may be determined based on an end of operations of the painting assembly 104. For example, the third duration (“T2m” to “T3”) may be a second preliminary amount of time (for example, 2-3 hours) required to reduce the heat of the components 104A of the painting assembly 104 from the threshold temperature “D2” to reach the pre-heating temperature “D1”. In an example, based on a completion of the painting process for the working day, the processor 102A may control the second heater 108 to reduce the heat from the threshold temperature “D2” to the pre-heating temperature “D1”. Once the pre-heating temperature “D1” is reached, the processor 102A may control the second heater 108 to maintain the pre-heating temperature “D1” until a next working day in the assembly line.

In the idling phase 510, the second heater 108 may be controlled to maintain the pre-heating temperature “D1”. In an embodiment, the processor 102A may be control the second heater 108 to maintain the pre-heating temperature “D1” from the third time instance “T3” to another maintenance time instance “T3m”. For example, another duration of the maintenance period (“T3” to “T3m”) may be a third amount of time (for example, 12 hours) required to maintain the heat of the components 104A of the painting assembly 104 in the pre-heating temperature “D1”. In the idling phase 510, the second heater 108 may utilize the clean-energy-based source (such as the solar energy source) to maintain the heat of the components 104A of the painting assembly 104 at the pre-heating temperature “D1”, with minimal carbon emissions, until the next working day in the assembly line.

In the re-heating phase 512, the second heater 108 may be controlled to re-heat the components 104A of the painting assembly 104. In an embodiment, the processor 102A may control the second heater 108 increase the heat for a fourth duration (“T3m” to “T4”) to maintain the heat for the components 104A of the painting assembly 104 at the threshold temperature “D2”. In some cases, the fourth duration (“T3m” to “T4”) may be determined based on the working of operations of the painting assembly 104. For example, when the next working day starts in the assembly line, the processor 102A may control the second heater 108 to increase the temperature from the pre-heating temperature “D1” to the threshold temperature “D2”. The re-heating phase 512 may start from end of the other maintenance time instance “T3m” and proceed till a fourth time instance “T4”. For example, the fourth duration (“T3m” to “T4”) may be a third preliminary amount of time (for example, 2-3 hours) required to heat the components 104A of the painting assembly 104 to reach the threshold temperature “D2” from the pre-heating temperature “D1”. In the re-heating phase 512, the second heater 108 may utilize the clean-energy-based source (such as the solar energy source) to heat the components 104A of the painting assembly 104 from the pre-heating temperature “D1” to the threshold temperature “D2”, with minimal carbon emissions.

In the cyclic phase 514, the second heater 108 may be controlled for the cyclic usage. In an embodiment, the processor 102A may control the second heater 108 for the cyclic usage of heat application on to the components 104A of the painting assembly 104. For example, the cyclic usage may correspond to the repeated schedule of heating the components 104A of the painting assembly 104, via the second heater 108, until a time instance “Tn”. The repeated schedule may indicate a repetition of heating phases for the components 104A of the painting assembly 104, such as, the repeated schedule of the maintenance phase 506, the supplementary control phase 508, an idling phase 510, the re-heating phase 512, and the cyclic phase 514. Such cyclic usage of the second heater 108 may provide carbon credits. In an example, the carbon credits may relate to information associated with the amount of carbon saved based on the cyclic usage of the second heater 108.

The chart shown in FIG. 5 is illustrated as discrete operations, such as from 502 to 514, which relates to control of the heat for components 104A of the painting assembly 104. However, in certain embodiments, such discrete operations may be further divided into additional operations, combined into fewer operations, or eliminated, depending on the particular implementation without detracting from the essence of the disclosed embodiments.

FIG. 6 depicts a chart that illustrates a second exemplary operation timeline of the controller of FIG. 1, to control the heat for components of the painting assembly, in accordance with an embodiment of the disclosure. FIG. 6 is explained in conjunction with elements from FIGS. 1, 2, 3, 4, and 5. With reference to FIG. 6, there is shown a chart 600 indicating a second exemplary operation timeline of the controller 102 which depicts different phases of operation of the painting assembly 104. The different phases may include, but not limited to, an initial heating phase 602, a supplementary heating phase 604, a maintenance phase 606, a shutdown phase 608, a re-starting phase 610, and a cyclic phase 612. It may be observed that the functions of the initial heating phase 602, the supplementary heating phase 604, the maintenance phase 606, and the cyclic phase 612, may be same as the functions of the initial heating phase 502, the supplementary heating phase 504, the maintenance phase 506, and the cyclic phase 514, as described respectively, for example, in FIG. 5. Therefore, the description of the initial heating phase 602, the supplementary heating phase 604, the maintenance phase 606, and the cyclic phase 612 were omitted from the disclosure for the sake of brevity.

In the shutdown phase 608, the second heater 108 may be controlled to reduce the temperature of the components 104A of the painting assembly 104 from the threshold temperature “D2” to the initial temperature “DO”. In an embodiment, the processor 102A may control the second heater 108, based on the completion of the painting process for the working day, to reduce the temperature of the components 104A of the painting assembly 104 from the threshold temperature “D2” to the initial temperature “DO”. For example, in case, around 7 pm the painting process may be completed for the working day. Based on the completion of the painting process assigned for the working day, the processor 102A may determine the heating process for the next working day. For example, if the working day is Monday and the next working day (such as Tuesday) is available within a certain period of time (such as 12 hours) for the assembly line to execute the painting process, the processor 102A may control the second heater 108 to move to the supplementary control phase 508 and the idling phase 510 (i.e., the reduction of heat from the threshold temperature “D2” to pre-heating temperature “D1” and maintain in the pre-heating temperature “D1” until the next working day).

In another embodiment, based on the end of operations of the painting assembly 104, the processor 102A may control the second heater 108 to stop the heat for the components 104A of the painting assembly 104. For example, if the working day is Friday and the next working day (such as Monday) is not available within the certain period of time (such as 12 hours) for the assembly line to execute the painting process, the processor 102A may control the second heater 108 to turn-off and save energy for a duration (such as a time period of Saturday and Sunday, between the working day, i.e., Friday and the next working day, i.e., Monday) until the next working day. In another embodiment, in case the painting assembly 104 exhausts its carbon emission limit, the processor 102A may control the first heater 106 and/or the second heater 108 to stop the heat for the components 104A of the painting assembly 104. The first heater 106 and/or the second heater 108 may be stopped based on a threshold of the carbon footprint in the painting assembly 104. The information associated with the carbon footprint is further described, for example, in FIG. 4.

In the re-starting phase 610, the first heater 106 may be controlled to heat the components 104A of the painting assembly 104 from the initial temperature “DO” to the threshold temperature “D2”. In an embodiment, the processor 102A may control the first heater 106 to directly heat the components 104A of the painting assembly 104 from the initial temperature “DO” to the threshold temperature “D2”. In some cases, the processor 102A may control the first heater 106 to increase the heat for a fifth duration (“T3” to “T4”) to maintain the heat for the components of the painting assembly at the threshold temperature until another duration of maintenance period (“T4” to “T4m”). The fifth duration (“T3” to “T4”) may be determined based on the working of operations of the painting assembly 104. For example, in case the user preference is to rapidly heat the components 104A of the painting assembly 104, the controller 102 may control the first heater 106 to increase the heat of the components 104A of the painting assembly 104 to directly reach the threshold temperature “D2” from the initial temperature “DO”. In such cases, the initial heating phase 602 and the supplementary heating phase 604 may not be required. Alternatively, in case the user preference is to limit carbon emissions in the painting assembly 104, the components 104A may undergo the initial heating phase 602, via the first heater 106, and the supplementary heating phase 604, via the second heater 108.

The line shown in FIG. 6 is illustrated as discrete operations, such as from 602 to 612, which relates to control of the heat for components 104A of the painting assembly 104. However, in certain embodiments, such discrete operations may be further divided into additional operations, combined into fewer operations, or eliminated, depending on the particular implementation without detracting from the essence of the disclosed embodiments.

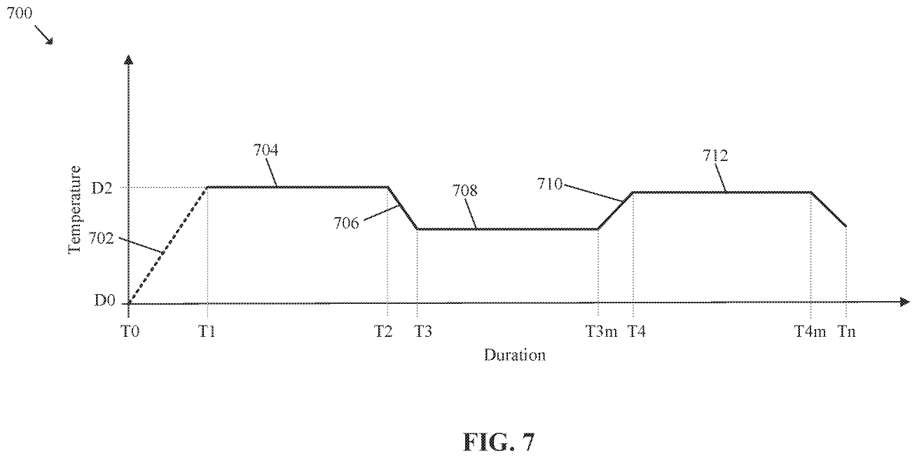

FIG. 7 depicts a chart that illustrates a third exemplary operation timeline of the controller of FIG. 1, to control the heat for components of the painting assembly, in accordance with an embodiment of the disclosure. FIG. 7 is explained in conjunction with elements from FIGS. 1, 2, 3, 4, 5, and 6. With reference to FIG. 7, there is shown a chart 700 indicating a third exemplary operation timeline of the controller 102, which depicts different phases of operation of the painting assembly 104. The different phases may include, but not limited to, a head-start phase 702.

In the head-start phase 702, the first heater 106 may be controlled to heat the components 104A of the painting assembly 104 from the initial temperature “DO” to directly reach the threshold temperature “D2” without the initial heating phase 502, via the first heater 106, and the supplementary heating phase 504, via the second heater 108 (shown in FIG. 5). In an embodiment, the processor 102A may control the first heater 106 to heat the components 104A of the painting assembly 104 from the initial temperature “DO” to directly reach the threshold temperature “D2”, at the start of operations of the painting assembly 104. It may be observed that the re-starting phase 610 (shown in FIG. 6) is performed after the end of the operations of the working day and before the start of operations of the next working day. However, the head-start phase 702 is performed at the start of the operations of the working day. Apart from a scheduling difference between the re-starting phase 610 and the head-start phase 702, the functions of the head-start phase 702 may be substantially same as the functions of the re-starting phase 610 described, for example, in FIG. 6. Further, different phases in the chart 700 may include a maintenance phase 704, a supplementary control phase 706, an idling phase 708, a re-heating phase 710, and a cyclic phase 712. The functions of the maintenance phase 704, the supplementary control phase 706, the idling phase 708, the re-heating phase 710, and the cyclic phase 712 may be similar to the functions of the maintenance phase 506, the supplementary control phase 508, the idling phase 510, the re-heating phase 512, and the cyclic phase 514, respectively, as described, for example, in FIG. 5.

The chart shown in FIG. 7 is illustrated as discrete operations, such as from 702 to 704, which relates to control of the heat for components 104A of the painting assembly 104. However, in certain embodiments, such discrete operations may be further divided into additional operations, combined into fewer operations, or eliminated, depending on the particular implementation without detracting from the essence of the disclosed embodiments.

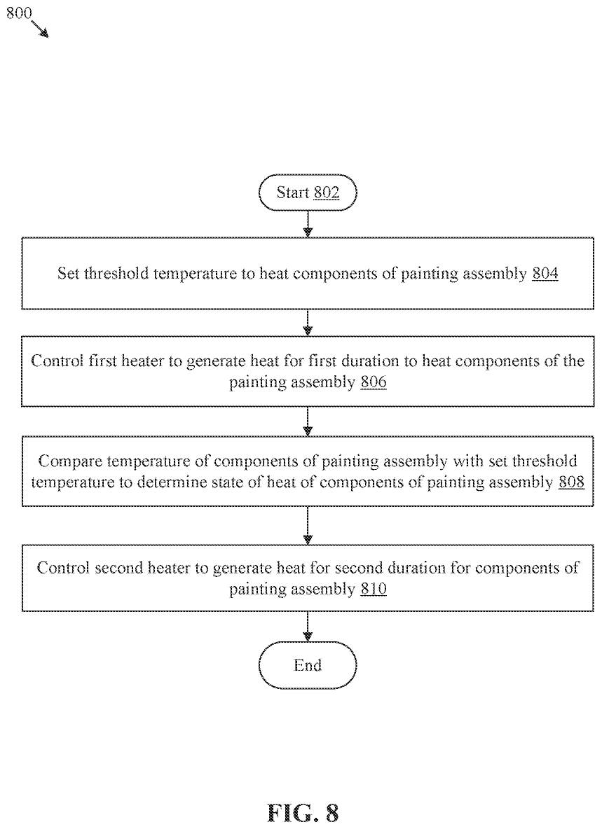

FIG. 8 is a flowchart that illustrates exemplary operations to control the heat for components of the painting assembly, in accordance with an embodiment of the disclosure. With reference to FIG. 8, there is shown a flowchart 800. The flowchart 800 is described in conjunction with FIGS. 1, 2, 3, 4, 5, 6, and 7. The operations from 802 to 802 may be implemented, for example, by the controller 102, the processor 102A, or the processor 202 of FIG. 2. The operations of the flowchart 800 may start at 802.

At 802, the threshold temperature D2 may be set to heat the components 104A of the painting assembly 104. In an embodiment, the processor 102A may set the threshold temperature D2, based on the carbon footprint, to heat the components 104A of the painting assembly, as described, for example, in FIGS. 1, 3, 4 and 7.

At 804, the first heater 106 may be controlled to generate the heat for the first duration to heat the components 104A of the painting assembly 104. In an embodiment, the processor 102A may control the first heater 106 to generate the heat for the first duration to heat the components 104A of the painting assembly 104, as described, for example, in FIGS. 1, 3, 4, and 5.

At 806, the temperature of the components 104A of the painting assembly 104 may be compared with the set threshold temperature D2 to determine the state of heat of components 104A of the painting assembly 104. In an embodiment, the processor 102A may compare the temperature of the components 104A of the painting assembly 104 with the set threshold temperature D2 to determine the state of heat of components 104A of the painting assembly 104, as described, for example, in FIGS. 1, 3, and 4.

At 808, the second heater 108 may be controlled to generate the heat for the second duration T2 for the components 104A of the painting assembly 104. In an embodiment, the processor 102A may control the second heater 108 to generate the heat for the second duration T2 for the components 104A of the painting assembly 104 based on the comparison, as described, for example, in FIGS. 1, 3, and 4. Control may pass to end.

The flow chart shown in FIG. 8 is illustrated as discrete operations, such as from 802 to 808, which relates to control of the heat for components 104A of the painting assembly 104. However, in certain embodiments, such discrete operations may be further divided into additional operations, combined into fewer operations, or eliminated, depending on the particular implementation without detracting from the essence of the disclosed embodiments.

Various embodiments of the disclosure may provide a non-transitory, computer-readable medium and/or storage medium, and/or a non-transitory machine readable medium and/or storage medium stored thereon, a set of instructions executable by a machine and/or a computer (for example the controller 102) to control the heat of the components 104A of the painting assembly 104. The set of instructions may be executable by the machine and/or the computer (for example the controller 102) to perform operations that may include setting of the threshold temperature to heat the components 104A of the painting assembly 104. The operations may further include control of the first heater 106 to generate the heat for the first duration for the components 104A of the painting assembly 104. The operations may further include comparison of a temperature of the components 104A of the painting assembly 104 with the set threshold temperature to determine a state of heat of the components 104A of the painting assembly 104. The operations may further include control of the second heater 108 to generate the heat for the second duration, determined based on the comparison, for the components 104A of the painting assembly 104.

The present disclosure may be realized in hardware, or a combination of hardware and software. The present disclosure may be realized in a centralized fashion, in at least one computer system, or in a distributed fashion, where different elements may be spread across several interconnected computer systems. A computer system or other apparatus adapted for carrying out the methods described herein may be suited. A combination of hardware and software may be a general-purpose computer system with a computer program that, when loaded and executed, may control the computer system such that it carries out the methods described herein. The present disclosure may be realized in hardware that includes a portion of an integrated circuit that also performs other functions. It may be understood that, depending on the embodiment, some of the steps described above may be eliminated, while other additional steps may be added, and the sequence of steps may be changed.

The present disclosure may also be embedded in a computer program product, which includes all the features that enable the implementation of the methods described herein, and which when loaded in a computer system is able to carry out these methods. Computer program, in the present context, means any expression, in any language, code or notation, of a set of instructions intended to cause a system with an information processing capability to perform a particular function either directly, or after either or both of the following: a) conversion to another language, code or notation; b) reproduction in a different material form. While the present disclosure has been described with reference to certain embodiments, it will be understood by those skilled in the art that various changes may be made, and equivalents may be substituted without departing from the scope of the present disclosure. In addition, many modifications may be made to adapt a particular situation or material to the teachings of the present disclosure without departing from its scope. Therefore, it is intended that the present disclosure is not limited to the particular embodiment disclosed, but that the present disclosure will include all embodiments that fall within the scope of the appended claims.

What is claimed is:

1. A controller for a painting assembly, comprising:
at least one processor configured to:
set a threshold temperature to heat components of the painting assembly, wherein the threshold temperature is set based on a carbon footprint in the painting assembly;
control a first heater to generate the heat for a first duration for the components of the painting assembly, wherein the first duration is determined based on the set threshold temperature;
compare a temperature of the components of the painting assembly with the set threshold temperature to determine a state of heat of the components of the painting assembly; and
control a second heater to generate the heat for a second duration for the components of the painting assembly, wherein the second duration is determined based on the comparison.

2. The controller according to claim 1, wherein
the first duration corresponds to a first amount of time required to heat the components of the painting assembly to reach the threshold temperature; and
the second duration corresponds to a second amount of time required to maintain the heat of the components of the painting assembly at the threshold temperature.

3. The controller according to claim 1, wherein
the first duration corresponds to a first amount of time required to heat the components of the painting assembly to reach a first temperature that is less than the threshold temperature, wherein the first temperature is determined based on the carbon footprint in the painting assembly; and
the second duration corresponds to a second amount of time required to reach the threshold temperature from the first temperature and maintain the heat of the components of the painting assembly at the threshold temperature.

4. The controller according to claim 1, wherein the first heater is controlled based on a first energy source and the second heater is controlled based on a second energy source, and wherein the first energy source is different form the second energy source.

5. The controller according to claim 4, wherein the first energy source comprises a first meter and the second energy source comprises a second meter, wherein
energy readings from the first meter corresponds to the carbon footprint in the painting assembly, wherein the carbon footprint relates to information associated with an amount of carbon spent based on a usage of the first heater; and
energy readings from the second meter corresponds to carbon credits for the painting assembly, wherein the carbon credits relate to information associated with an amount of carbon saved based on a usage of the second heater.

6. The controller according to claim 1, wherein the at least one processor is further configured to:
control switching between the first heater and the second heater to generate the heat for the components of the painting assembly based on a user preference, and wherein the user preference is based on the carbon footprint in the painting assembly.

7. The controller according to claim 1,
wherein the first duration is based on a start of operations of the painting assembly;
wherein the second duration is based on a working of operations of the painting assembly; and
wherein the at least one processor is further configured to control the second heater to reduce the heat for a third duration for the components of the painting assembly, wherein the third duration is based on an end of operations of the painting assembly.

8. The controller according to claim 7, wherein the at least one processor is further configured to:
control the second heater to increase the heat for a fourth duration to maintain the heat for the components of the painting assembly at the threshold temperature, wherein the fourth duration is based on the working of operations of the painting assembly.

9. The controller according to claim 7, wherein the at least one processor is further configured to:
control the second heater to stop the heat for the components of the painting assembly, wherein the second heater is stopped based on the end of operations of the painting assembly; and
control the first heater to increase the heat for a fifth duration to maintain the heat for the components of the painting assembly at the threshold temperature, wherein the fifth duration is based on the working of operations of the painting assembly.

10. The controller according to claim 1, wherein the at least one processor is further configured to:
control the first heater to stop the heat for the components of the painting assembly, wherein the first heater is stopped based on a threshold of the carbon footprint in the painting assembly.

11. The controller according to claim 1, wherein the at least one processor is further configured to:
control the second heater to stop the heat for the components of the painting assembly, wherein the second heater is stopped based on a threshold for carbon credits in the painting assembly.

12. The controller according to claim 1, wherein the components of the painting assembly comprise a paint, and wherein each of the first heater and the second heater is configured to control a temperature of the paint in the painting assembly.

13. The controller according to claim 1, wherein the components of the painting assembly comprise a painted component, and wherein each of the first heater and the second heater is configured to cure the painted component in the painting assembly.

14. The controller according to claim 1, wherein the carbon footprint in the painting assembly is offset based on a cyclic usage of the second heater, and wherein the cyclic usage corresponds to a repeated schedule of heating the components of the painting assembly, via the second heater.

15. The controller according to claim 14, wherein
the carbon footprint relates to information associated with an amount of carbon spent based on a usage of the first heater in the painting assembly; and
the cyclic usage of the second heater provides carbon credits, wherein the carbon credits relate to information associated with an amount of carbon saved based on a usage of the second heater, and
wherein the at least one processor is configured to compare the amount of carbon spent with the amount of carbon saved to determine offset of the carbon footprint.

16. The controller according to claim 1, wherein each of the first heater and the second heater is configured to concurrently heat the components of the painting assembly to reach the threshold temperature.

17. The controller according to claim 1,
wherein the first heater comprises at least one of: a natural gas-based heater, a coal-based heater, an oil-based heater, or a fossil fuel-based heater, and
wherein the second heater comprises at least one of: a solar energy-based heater, a wind energy-based heater, a geothermal energy-based heater, or a hydro-power based-heater.

18. A painting assembly, comprising:
a first heater coupled to components of the painting assembly, wherein the first heater is configured to generate heat for a first duration to heat the components of the painting assembly, and wherein the first duration is determined based on a threshold temperature that is set to control a carbon footprint in the painting assembly; and
a second heater coupled to the components of the painting assembly, wherein the second heater is configured to generate heat for a second duration to heat the components of the painting assembly, wherein
the second duration is determined based on a comparison of a temperature of the components of the painting assembly with the threshold temperature and wherein the temperature of the components indicates a state of heat of the components of the painting assembly.

19. The painting assembly according to claim 18, further comprising:
a controller configured to:
set the threshold temperature to the heat the components of the painting assembly, wherein the threshold temperature is set based on the carbon footprint in the painting assembly;
control the first heater to generate heat for the first duration to heat the components of the painting assembly;
compare the temperature of the components of the painting assembly with the set threshold temperature to determine the state of heat of the components of the painting assembly; and
control the second heater to generate the heat for the second duration for the components of the painting assembly.

20. A method, comprising:
in a controller for a painting assembly:
setting a threshold temperature to heat components of a painting assembly, wherein the threshold temperature is set based on a carbon footprint in the painting assembly;
controlling a first heater to generate the heat for a first duration to heat the components of the painting assembly, wherein the first duration is determined based on the threshold temperature;
comparing a temperature of the components of the painting assembly with the set threshold temperature to determine a state of heat of the components of the painting assembly; and
controlling a second heater to generate the heat for a second duration for the components of the painting assembly, wherein the second duration is determined based on the comparison.
